(19) United States
(12) Patent Application Publication
(10) Pub. No.: US 2024/0414521 A1
(43) Pub. Date: Dec. 12, 2024

(54) LEDGER REGISTRY FOR MOBILE SUBSCRIPTION MANAGEMENT

(71) Applicant: Amazon Technologies, Inc., Seattle, WA (US)

(72) Inventors: Michael Sean Nearing, Barrie (CA); Nayef Mohammed Khan, East Gwillimbury (CA); Ajay Bhimrao Rane, Irvine, CA (US); MohammadHossein Zoualfaghari, Woodbridge (GB)

(21) Appl. No.: 18/333,244

(22) Filed: Jun. 12, 2023

(51) Int. Cl. H04W 8/20; H04W 12/03

(52) U.S. Cl. CPC H04W 8/205; H04W 12/03

(57) ABSTRACT

Disclosed are various embodiments for a discovery service ledger registry used in the process of provisioning electronic subscriber identity modules (SIMs). In one embodiment, an event registration request is received by a subscription manager discovery service (SM-DS) abstraction layer from an entity operated by or on behalf of a connectivity service provider (CSP). The event registration request specifying a unique device hardware identifier and at least one of: a subscription manager data preparation (SM-DP) address or a SM-DP+ address associated with the CSP. The abstraction layer sends the event registration request to an SM-DS. The abstraction layer records the event registration request via a ledger registry service.

### BACKGROUND

Cellular networks dating back to the Global System for Mobile Communications (GSM) have used subscriber identity module (SIM) cards in order to authorize wireless devices to access the networks. A SIM card, also referred to as a universal integrated circuit card (UICC), is a removable smart card with an embedded integrated circuit and contacts. The SIM card stores an integrated circuit card identifier (ICCID), which is a unique serial number, an international mobile subscriber identity (IMSI) number, network authorization data, personal security keys, and other information. In order to switch a wireless device from a first mobile network to a second mobile network, a user may remove a first SIM card associated with the first mobile network from the wireless device, replacing it with a second SIM card associated with the second mobile network in the wireless device. To upgrade wireless devices and remain on the same mobile network with the same phone number, a user may simply take the SIM card out of the older device and insert it into the newer device. SIM cards have continued to be used in standards set forth by the Third Generation Partnership Project (3GPP), such as the third-generation (3G) Universal Mobile Telecommunications System (UMTS), the fourth-generation (4G) Long-Term Evolution (LTE) standard, and the fifth-generation (5G) New Radio (NR) standard.

However, an alternative to SIM cards, embedded SIMs (eSIMs), are becoming widely used, replacing traditional SIM cards in newer models of wireless devices. With eSIMs, the removable smart card is replaced with a chip that is permanently soldered into the wireless device. This chip is referred to as the embedded UICC (eUICC). The eUICC stores profile information that would be on the traditional SIM card, such as the ICCID and a carrier-generated network authentication key, and this information can be reprogrammed on the eUICC, e.g., to switch wireless carriers. In some cases, multiple SIM profiles may be stored in an eSIM. In addition, each eSIM is factory-programmed with a permanent eSIM identifier (eID), a serial number that cannot be changed.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIG. 2A is a schematic block diagram of one example of a transaction ledger according to various embodiments of the present disclosure.

FIG. 2B shows one example of a networked environment with an example deployment of the entitlement service aggregation layer from FIG. 1 according to various embodiments of the present disclosure.

FIG. 3A is a sequence diagram illustrating one example of component interactions to register events in the networked environment of FIG. 1 according to various embodiments of the present disclosure.

FIG. 3B is a sequence diagram illustrating one example of component interactions in eSIM discovery event retrieval in the networked environment of FIG. 1 according to various embodiments of the present disclosure.

FIG. 3C is a sequence diagram illustrating one example of component interactions to delete events in the networked environment of FIG. 1 according to various embodiments of the present disclosure.

FIGS. 4A and 4B are flowcharts illustrating examples of functionality implemented as portions of an alternative Subscription Manager Discovery Service (SM-DS) executed in a computing environment in the networked environment of FIG. 1 according to various embodiments of the present disclosure.

FIGS. 4C and 4D are flowcharts illustrating examples of functionality implemented as portions of a ledger registry service executed in a computing environment in the networked environment of FIG. 1 according to various embodiments of the present disclosure.

FIGS. 5A and 5B are flowcharts illustrating examples of functionality implemented as portions of an entitlement service aggregation layer executed in a computing environment in the networked environment of FIG. 1 according to various embodiments of the present disclosure.

FIGS. 6A and 6B are flowcharts illustrating examples of functionality implemented as portions of a device registry executed in a computing environment in the networked environment of FIG. 1 according to various embodiments of the present disclosure.

FIG. 6C is a flowchart illustrating an example of functionality implemented as portions of a device ordering system executed in a computing environment in the networked environment of FIG. 1 according to various embodiments of the present disclosure.

FIG. 7 is a schematic block diagram that provides one example illustration of a computing environment employed in the networked environment of FIG. 1 according to various embodiments of the present disclosure.

### DETAILED DESCRIPTION

The present disclosure relates to mobile subscription management, and more particularly to a discovery service ledger registry for eSIM provisioning, an entitlement service aggregation layer, and a device registry. Wireless devices with eSIMs connect to a root Subscription Manager Discovery Service (SM-DS) as part of provisioning and activation of a subscription with a connectivity service provider (CSP) or carrier (also known in some cases as mobile network operators (MNOs)). A root SM-DS is operated by the GSM Association (GSMA), but other root SM-DSes may be used, such as those operated by or on behalf of device manufacturers. The SM-DS is used to provide a Subscription Manager Data Preparation (SM-DP+) address to a wireless device. Each CSP may operate their own respective SM-DP+ for eSIM provisioning, and in some cases the SM-DP+ is operated on behalf of the CSP by the device manufacturer or other entities. It is noted that the SM-DP+ entity is typically used for consumer devices, while an SM-DP entity may be used for Internet of Things (IoT) or Machine to Machine (M2M) devices.

In Event Registration, the CSP's SM-DP+ informs the root SM-DS that it has a SIM profile for a particular device identified by an eID. The root SM-DS creates an Event Record to associate the eID with the SM-DP+ address. In Event Checking, the device, by virtue of being powered on or configured to check for a new profile, then contacts the root SM-DS to determine whether any new profile is waiting for the device. In Event Retrieval, the root SM-DS then responds with the address of the CSP's SM-DP+ that has the profile for the device. The device connects to the SM-DP+ address, downloads the profile to the eUICC, and then uses the profile to connect to the CSP's network. In Event Deletion, the SM-DP+ deletes the Event Record from the SM-DS.

However, there is no mechanism to verify a transaction history with respect to device elDs. This can be problematic in that, with eSIMs, users can switch CSPs without even notifying the CSP. With SIM cards, CSPs could track network changes based on the change in the SIM card, but that is not available with eSIMs. Also, with multiple root SM-DSes now available, including device manufacturer-specific root SM-DSes, CSPs have been forced to integrate with each of the multiple root SM-DSes.

Various embodiments of the present disclosure introduce approaches to ensure that eSIM SM-DS transactions are stored in an immutable and cryptographically verifiable registry. The registry acts as a ledger of requests and responses to the SM-DS that provides a reliable independent transaction history across CSPs and root SM-DS providers. In one or more embodiments, an abstraction layer can connect a plurality of root SM-DSes from organizations. This enables multi-vendor or multi-party transactions to communicate across ecosystems in a matter that is anonymized, decentralized, and traceable.

The present disclosure also relates to an entitlement service aggregation layer. An entitlement is a service or feature that is enabled and available on a cellular network device. Specifically, an entitlement represents the combination of what services or features are available to be enabled on a device, as established by a device manufacturer, what services or features are supported by the CSP and its backend systems, and what services or features are subscribed to by the user. Non-limiting examples of entitlements may include FACETIME over cellular, WI-FI calling via ICLOUD, visual voice mail, mobile hotspot or tethering, 5G support, LTE support, unlocking, voice over LTE (VoLTE), eSIM support, and so on.

As devices are transitioning from the traditional SIM model to eSIMs, CSPs are having to operate entitlement services to enable eSIM provisioning. As entitlement services are device manufacturer-specific, each CSP is having to integrate with a multitude of device manufacturer systems. Each time a new manufacturer system comes online, or if the application programming interface (API) for an existing manufacturer system changes, the burden rests on the CSP in order to integrate and maintain the integrations.

Various embodiments of the present disclosure introduce an entitlement service aggregation layer that is made available for use potentially by a plurality of CSPs. The entitlement service aggregation layer provides a common API for a plurality of entitlement services that integrate with a plurality of supported device manufacturer systems. Rather than integrating, and maintaining integrations, with a plurality of device manufacturer systems, the entitlement service aggregation layer enables the CSP to integrate with just the aggregation layer using the common API. Any updates or changes to the integrations are handled by the provider of the entitlement service aggregation layer, rather than the CSP. As will be described, transactions involving the entitlement service aggregation layer may be recorded by the ledger registry service.

The present disclosure also relates to a device registry and device ordering workflow. The GSMA operates a global registry on behalf of the mobile industry that is used to flag the International Mobile Equipment Identity (IMEI) of devices that are reported as stolen. However, the GSMA registry has limited functionality, and there is not currently a global registry that maps devices to CSPs. As a consequence, CSPs often may have difficulty knowing what devices are currently on their networks. For example, this problem may apply when SIM cards are swapped, when a device switches among dual SIM cards, or when a new eSIM profile is provisioned for a device.

Various embodiments of the present disclosure provide a device registry that maintains information on cellular devices as aggregated from device manufacturers, CSPs, GSMA, and/or other sources. For example, the device registry can receive feeds of information on device capabilities (e.g., what features or functions are available on device) from respective device manufacturers. The device registry can also receive information from CSP sources, including information identifying devices on the CSP's network from the CSP's business support system (BSS) and information about entitlements. In addition to supporting queries from CSPs, device manufacturers, and/or other entities with permission, the device registry may also facilitate an online ordering workflow that enables users to shop for devices and plans from CSPs, where users can filter devices and CSPs by entitlements that they want. With entitlement selection in advance, an eSIM profile may be preconfigured on the device to facilitate quick device activation with the desired entitlements. For example, the device with an eSIM may be preconfigured with bootstrap code, where the bootstrap code causes the device to connect to a CSP or a cloud provider network in an initial quarantine period. In the initial quarantine period, an eSIM profile may be loaded on the device by the CSP or cloud provider network with the user's plan selections or entitlements. As will be described, data in the device registry may be recorded by the ledger registry service.

As one skilled in the art will appreciate in light of this disclosure, certain embodiments may be capable of achieving certain advantages, including some or all of the following: (1) improving the functioning of cellular networks by creating an immutable and cryptographically verifiable registry of discovery service transactions, entitlement service transactions, device capabilities and network history; (2) simplifying CSP architectures by integrating with one abstraction layer instead of with multiple root SM-DS providers, thereby reducing potential for errors and enabling faster integration with proliferating root SM-DS providers; (3) simplifying CSP architectures by integrating with one entitlement service aggregation layer instead of with multiple entitlement services for multiple device manufacturer systems, thereby reducing potential for errors and enabling faster integration with proliferating device manufacturers; (4) improving the functioning of computer systems by including active components in a device ordering workflow to filter devices and CSPs by capabilities and also to facilitate eSIM profile pre-provisioning for the desired CSP and entitlements; and so forth.

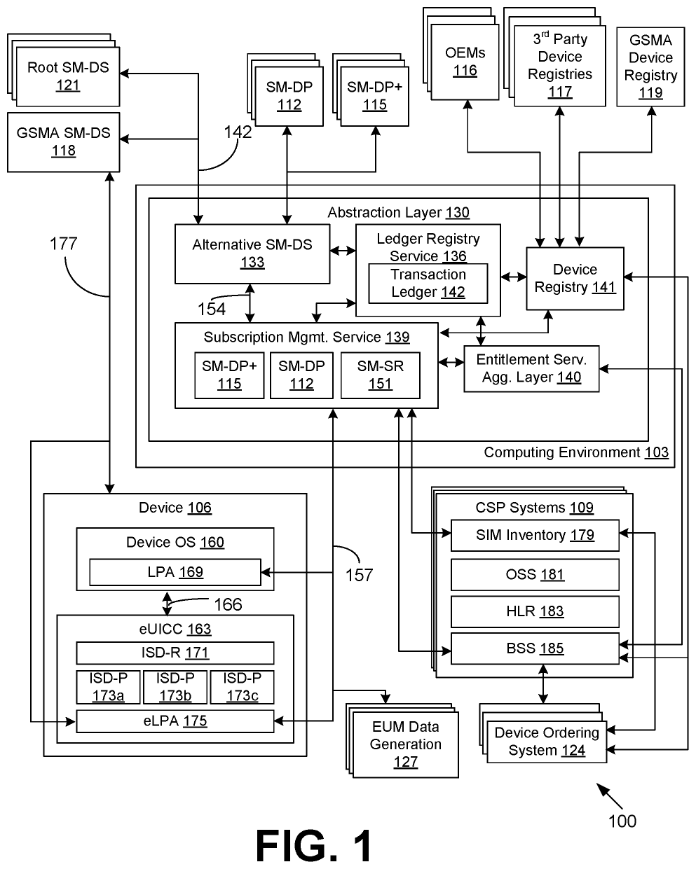

With reference to FIG. 1, shown is a networked environment 100 according to various embodiments. The networked environment 100 includes a computing environment 103, one or more devices 106, one or more CSP systems 109, one or more SM-DPs 112, one or more SM-DP+s 115, one or more device manufacturer systems (OEMs) 116, one or more third party device registries 117, a GSMA SM-DS 118, a GSMA device registry 119, one or more root SM-DSes 121, one or more device ordering systems 124, and one or more eUICC manufacturers (EUM) data generation systems 127, which may be in data communication via various network interfaces. The network interfaces may include, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time. In one embodiment, the computing environment 103 may be implemented in one or more edge servers at an edge location (e.g., a cell site) of a CSP network.

The computing environment 103 may be hosted within a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

The cloud provider network can provide on-demand, scalable computing services to users through a network, for example, allowing users to have at their disposal scalable “virtual computing devices” via their use of the compute servers (which provide compute instances via the usage of one or both of central processing units (CPUs) and graphics processing units (GPUs), optionally with local storage) and block store servers (which provide virtualized persistent block storage for designated compute instances). These virtual computing devices have attributes of a personal computing device including hardware (various types of processors, local memory, random access memory (RAM), hard-disk, and/or solid-state drive (SSD) storage), a choice of operating systems, networking capabilities, and pre-loaded application software. Each virtual computing device may also virtualize its console input and output (e.g., keyboard, display, and mouse). This virtualization allows users to connect to their virtual computing device using a computer application such as a browser, API, software development kit (SDK), or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires.

A cloud provider network can be formed as a number of regions, where each region represents a geographical area in which the cloud provider clusters data centers. Each region can further include multiple (e.g., two or more) availability zones (Azs) connected to one another via a private high-speed network, for example, a fiber communication connection. An AZ may provide an isolated failure domain including one or more data center facilities with separate power, separate networking, and separate cooling from those in another AZ. Preferably, AZs within a region are positioned far enough away from one another such that a same natural disaster (or other failure-inducing event) should not affect or take more than one AZ offline at the same time. Customers can connect to an AZ of the cloud provider network via a publicly accessible network (e.g., the Internet, a cellular communication network).

Transit Centers (TC) are the primary backbone locations linking customers to the cloud provider network and may be co-located at other network provider facilities (e.g., Internet service providers, telecommunications providers). Each region can operate two or more TCs for redundancy.

The parenting of a given edge location to an AZ or region of the cloud provider network can be based on a number of factors. One such parenting factor is data sovereignty. For example, to keep data originating from a communication network in one country within that country, the edge locations deployed within that communication network can be parented to AZs or regions within that country. Another factor is availability of services. For example, some edge locations may have different hardware configurations such as the presence or absence of components such as local non-volatile storage for customer data (e.g., solid state drives), graphics accelerators, etc. Some AZs or regions might lack the services to exploit those additional resources, thus, an edge location could be parented to an AZ or region that supports the use of those resources. Another factor is the latency between the AZ or region and the edge location. While the deployment of edge locations within a communication network has latency benefits, those benefits might be negated by parenting an edge location to a distant AZ or region that introduces significant latency for the edge location 303 to region traffic. Accordingly, edge locations are often parented to nearby (in terms of network latency) AZs or regions.

Various applications and/or other functionality may be executed in the computing environment 103 according to various embodiments. Also, various data may be stored in a data store that is accessible to the computing environment 103. The data stored in the data store, for example, is associated with the operation of the various applications and/or functional entities described below.

The components executed on the computing environment 103, for example, include an abstraction layer 130, and other applications, services, processes, systems, engines, or functionality not discussed in detail herein. The abstraction layer 130 is executed to implement eSIM provisioning functionality for a plurality of different CSPs. The abstraction layer 130 is integrated with the GSMA SM-DS 118 and one or more root SM-DSes 121 that may be operated by device vendors or other entities, thereby removing the need for the CSPs to integrate their SM-DPs 112 and SM-DP+s 115 with all of the different SM-DSes that may arise. In addition, the abstraction layer 130 implements registry functionality to record data relating to the eSIM provisioning transactions so that CSPs, device vendors, and/or other entities can access data (in some cases, anonymized) relating to the eSIM provisioning transactions.

In some cases, the abstraction layer 130 may be operated by a centralized provider in a globally accessible instance. In other cases, the abstraction layer 130 may be operated in separate instances on behalf of the respective CSPs. In some scenarios, the abstraction layer 130 may be operated on one or more edge servers at an edge location of the CSP's network. In such cases, the abstraction layer 130 may be configured to operate in a disconnected mode from the edge server, where the abstraction layer 130 loses network connectivity to external services, such as the root SM-DS 121, the GSMA SM-DS 118, and/or other services.

Components of the abstraction layer 130 may include an alternative SM-DS 133, a ledger registry service 136, a subscription management service 139, an entitlement service aggregation layer 140, a device registry 141, and/or other components. The alternative SM-DS 133 is an SM-DS used in cascade mode with a root SM-DS 121 (or the GSMA SM-DS 118) to redirect event registration from an SM-DP+ to that root SM-DS 121. The device 106 polls the root SM-DS 121 (or the GSMA SM-DS 118) and receives an address of the alternative SM-DS 133, rather than the address of an SM-DP+ 115. The device 106 then requests the event from the alternative SM-DS 133, which will then response with the address of an SM-DP+ 115.

The alternative SM-DS 133 may be in communication with one or more root SM-DSes 121 and the GSMA SM-DS 118 by way of a network interface 142, which is an ES15 interface to connect cascaded SM-DSes. The alternative SM-DS 133 may be in communication with one or more SM-DPs 112 and/or one or more SM-DP+s 115 that are operated by the CSPs or on behalf of the CSPs (e.g., by EUMs).

The alternative SM-DS 133 of the present disclosure is configured to record eSIM discovery transaction information (e.g., event registrations, event deletions) with a ledger registry service 136. The ledger registry service 136 records the information on a transaction ledger 142. The transaction ledger 142 may employ distributed ledger technology and/or Blockchain technology in order to record the transactions in an immutable and cryptographically verifiable manner. The ledger registry service 136 is also configured to respond to search queries for the information stored in the transaction ledger 142. The ledger registry service 136 may also maintain one or more indices for the transaction ledger 142, such as by unique device hardware identifiers (e.g., eIDs). While the transaction ledger 142 may be configured to be immutable, upon request (e.g., in order to meet data protection regulations), the ledger registry service 136 may be configured to discard one or more cryptographic keys associated with transactions in the transaction ledger 142, effectively rendering those transactions inaccessible.

In some embodiments, a root SM-DS 121 may be configured to record eSIM discovery transaction information (e.g., event registrations, event deletions) with the ledger registry service 136 in lieu of, or in addition to, the integration of the ledger registry service 136 with an alternative SM-DS 133. In some embodiments, the abstraction layer 130 may support an offline mode for devices 106 that are on isolated or disconnected networks, such as private radio access networks. Operating a root SM-DS 121 along with the subscription management service 139 in the abstraction layer 130 can facilitate discovery and provisioning of devices 106 with eSIMs on networks that are isolated or disconnected temporarily or permanently from the Internet.

The subscription management service 139 may be used to integrate subscription management provisioning functions with the alternative SM-DS 133. For instance, the subscription management service 139 may include an SM-DP+ 115, an SM-DP 112, Subscription Manager Secure Routing (SM-SR) 151, operated by the entity that operates the abstraction layer 130 on behalf of a CSP rather than being operated by a CSP or another entity (e.g., EUM) on behalf of a CSP. The SM-SR 151 entity is configured to securely deliver CSP credentials to an eSIM, and remotely manages the eSIM thereafter. The subscription management service 139 may be in communication with the alternative SM-DS 133 by way of a network interface 154, corresponding to an ES12 interface that allows an SM-DP to register event records with the alternative SM-DS 133 and to delete its event records. The subscription management service 139 may be in communication with the devices 106 and/or the EUM data generation system(s) 127 via a network interface 157, which may correspond to an ES9+ interface that is used to provide a secure transport for the delivery of a bound eSIM profile package between the SM-DP+ 115 and the device 106.

The device 106 is representative of a plurality of different user equipment (UE) devices with capability to connect wirelessly to a mobile network operated by a CSP. The device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, Internet of Things (IoT) devices, machine-to-machine devices (MSM), or other devices.

Among other components, the device 106 may include a device operating system (OS) 160 and an eUICC 163. The device OS 160 and the eUICC 163 may be in communication via an interface 166, which may correspond to an ES10 interface used by the device 106 to get the configured addresses for the eUICC 163 for the root SM-DS 121 (or GSMA SM-DS 118), to transfer a bound eSIM profile package to the eUICC 163, for local profile management, and/or for profile content management. A local profile assistant (LPA) 169 may be a system application of the device OS 160. The LPA 169 manages the eSIM profiles and functions as an intermediary between the SM-DP+ 115 and the eUICC 163.

The eUICC 163 may include an Issuer Security Domain-Root (ISD-R) 171, one or more Issuer Security Domain-Profiles (ISD-Ps) 173a, 173b, 173c, and an electronic LPA (eLPA) 175, among other components. The ISD-R 171 is responsible for the creation of new ISD-Ps 173 and the lifecycle management for the ISD-Ps 173. The ISD-Ps 173 are secure containers for the hosting of an eSIM profile. The ISD-P 173 is the eUICC 163 representative for the SM-DP+ 115 and is used for profile download and installation. The electronic LPA 175 may correspond to the eUICC 163 representative of the LPA 169. The network interface 177 provides connectivity between the device 106 and the eLPA 175 and the GSMA SM-DS 118, or the root SM-DS 121. The network interface 177 may correspond to an ES11 interface that allows the device 106 and/or the eLPA 175 to retrieve event records for the respective eUICC 163 from the GSMA SM-DS 118 or the root SM-DS 121.

The CSP systems 109 are operated by or on behalf of CSPs. Non-limiting examples of CSPs may include telecommunications carriers, cloud provider networks, enterprises or organizations operating their own mobile networks, and so forth. Components of the CSP systems 109 may include a SIM inventory 179, an operations support system (OSS) 181, a home location register (HLR) 183, a business support system (BSS) 185, and/or other components. The SIM inventory 179 may include a number of eSIM profiles that are ready to be provisioned to a device 106. The OSS 181 may perform functions for the CSP such as order management, network inventory management, network operations, and so on. The HLR 183 may correspond to a database of subscriber information, including phone numbers, service entitlements, number porting history, and so on. The BSS 185 may perform functions for the CSP such as order receipt, customer relationship management, billing, and so on.

The device ordering system 124 may provide functionality for customers to order devices and subscriptions for wireless services through the CSP and provide payment information. The device ordering system 124 may be in communication with the SIM inventory 179 and/or the BSS 185 of the device ordering system 124. In some embodiments, the device ordering system 124 may be CSP-specific, while in other embodiments the device ordering system 124 is operated by a third party to allow discovery and ordering of plans from multiple CSPs. In some examples, the device ordering system 124 may be incorporated into or used by an online or digital store that sells consumer electronics such as smartphones, among other items. The digital store may be operated by a CSP, by a cloud provider, or another entity.

The device manufacturer systems 116 correspond to systems operated by the original equipment manufacturers (OEMs) that manufacture devices 106 for use on cellular radio-based networks. Such devices 106 may comprise mobile devices, such as smartphones and tablets, and Internet of Things (IoT) or Machine to Machine (M2M) devices. The device manufacturer systems 116 may have respective APIs for querying device capabilities or supported entitlements. For example, a device manufacturer system 116 may be queried based upon a unique device hardware identifier and then respond with a list of supported entitlements or capabilities. The device manufacturer system 116 in some embodiments may supply on-demand or periodic data feeds with device information, correlating the supported entitlements with unique device hardware identifiers. The device manufacturer systems 116 may also support respective APIs for enabling or disabling entitlements on individual devices 106 behalf of the CSP.

The third-party device registries 117 may maintain information about individual devices 106, such as CSP activation status, supported entitlements or capabilities, enabled entitlements, disabled entitlements, and so on. In some embodiments, the third-party device registries 117 may provide device information in association with unique device hardware identifiers in the form of data feeds, which may be provided on-demand or periodically.

The GSMA device registry 119 corresponds to a device registry operated by the GSMA. For example, the GSMA device registry 119 may provide information indicating whether devices 106 identified by a unique device hardware identifier are reported as stolen. In some embodiments, the GSMA device registry 119 may provide device information in association with unique device hardware identifiers in the form of data feeds, which may be provided on-demand or periodically.

The entitlement service aggregation layer 140 is executed to manage entitlements by way of an interconnection between CSP systems 109 operated by or on behalf of a plurality of CSPs (e.g., the BSS 185) and device manufacturer systems 116 operated by or on behalf of a plurality of device manufacturers. A CSP system 109 need only integrate with the common API supported by the entitlement service aggregation layer 140 rather than different APIs of each of the device manufacturer systems 116. In managing entitlements, the entitlement service aggregation layer 140 may receive supported device entitlement information or device capabilities from the device manufacturer systems 116 and provide this information to the CSP systems 109. The entitlement service aggregation layer 140 may also facilitate enabling or disabling entitlements for the CSP systems 109, where the enabling/disabling is ultimately performed on the device 106 by the device manufacturer systems 116. The entitlement service aggregation layer 140 may record all transaction information (e.g., information about supported device entitlements, and enabling/disabling entitlements) in the transaction ledger 142 by way of the ledger registry service 136.

The device registry 141 is configured to maintain via the ledger registry service 141 a device history regarding devices 106. For example, the device registry 141 may receive periodic or on-demand data feeds from device manufacturer systems 116, third-party device registries 117, the GSMA device registry 119, and so on. These data feeds may indicate device capabilities (e.g., supported entitlements), device features (e.g., screen size, resolution, hardware characteristics), and/or other device information in association with unique device hardware identifiers. The device registry 141 may also aggregate provider information about devices 106 from CSP systems 109 such as activation history, entitlement history, usage information, and/or other information. The device registry 141 may be queried based on a unique device hardware identifier and/or other data to provide a complete history for a device 106.

In addition, information from the device registry 141 may be utilized by the device ordering system 124 in order to facilitate a device ordering experience that allows filtering devices 106 and CSPs based at least in part on desired or target entitlements that are supported both by the devices 106 and one or more CSPs. For example, as described above, the device ordering system 124 may be used in the setting of an online store that enables customers to order smartphones and other user equipment that is able to connect to a wireless network. The customer can begin by browsing the devices which are available in the store, applying various filters or using keyword searching to determine which device they are interested in. Once the customer has selected a device, the online store can present the customer with options for plans (e.g., cell phone plans/wireless connectivity plans) that are available for the device. In some implementations, these plans may span multiple different carriers that have plans compatible with the selected device. Customers may be able to filter these plans based on the entitlements that they want, such as plans that allow mobile hotspots, unlimited voice calling, or unlimited SMS (“text messaging”), to name a few examples. Once the customer has ordered both a device and a plan, the store operator can use the device ordering system 124 to automatically preconfigure the device with the correct eSIM profile corresponding to their selected carrier and plan, so that the device just simply starts up when the customer receives it. Beneficially, this can help the customer by removing the requirement that they implement any kind of setup process after receiving their new device.

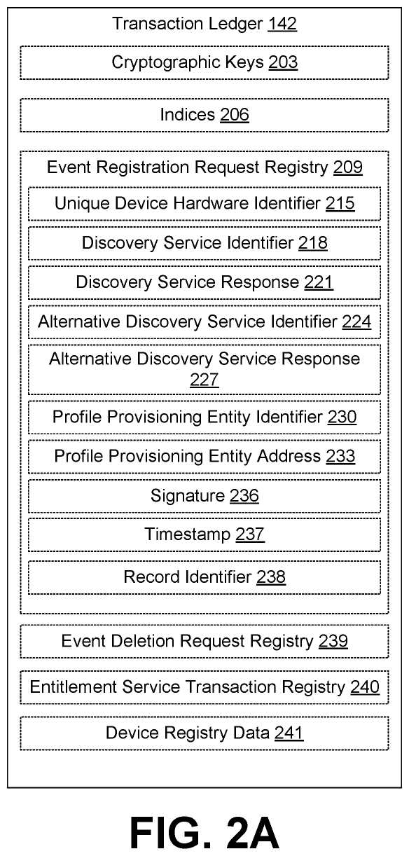

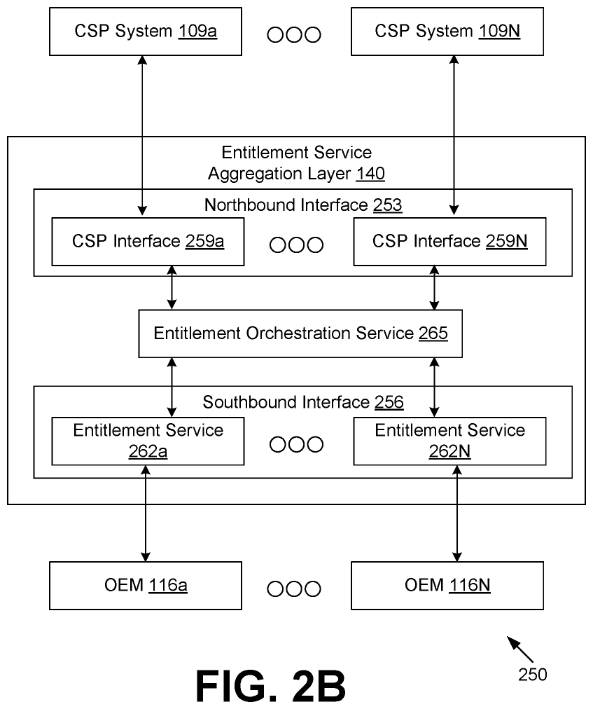

Turning now to FIG. 2A, shown is a block diagram of one example of a transaction ledger 142 maintained by the ledger registry service 136 (FIG. 1) according to one or more embodiments. The transaction ledger 142 may include one or more cryptographic keys 203, one or more indices 206, an event registration request registry 209, an event deletion request registry 239, an entitlement service transaction registry 240, device registry data 241, and/or other data.

The cryptographic keys 203 may be used to encrypt and generate a signature for individual records in the transaction ledger 142. A public-private key pair may be used to encrypt and verify one or more of the records in the transaction ledger 142. The private key, which is accessible by the ledger registry service 136, is used to encrypt the data and generate signatures. The public key, which may be externally accessible, is used to cryptographically verify the signatures. The indices 206 are used for searching the transaction ledger 142 for certain transactions of interest. For example, one of the indices 206 may be indexed by a unique device hardware identifier.

The event registration request registry 209 may include a plurality of different eSIM registration or provisioning events. For example, each record in the event registration request registry 209 may include a unique device hardware identifier 215, a discovery service identifier 218, a discovery service response 221, an alternative discovery service identifier 224, an alternative discovery service response 227, a profile provisioning entity identifier 230, a profile provisioning entity address 233, a signature 236, a timestamp 237, a record identifier 238, and or other data.

The unique device hardware identifier 215 uniquely identifies a device 106 (FIG. 1) based upon an immutable identifier manufactured into the device 106. For example, the unique device hardware identifier 215 may comprise an eID stored within the eUICC 163 (FIG. 1). The discovery service identifier 218 may identify the root SM-DS 121 (FIG. 1) or GSMA SM-DS 118 (FIG. 1) that the LPA 169 (FIG. 1) or eLPA 175 (FIG. 1) on the device 106 reaches out to in order to provision or register an eSIM profile. The discovery service response 221 indicates the response of the root SM-DS 121 or GSMA SM-DS 118, which may be the address of the alternative SM-DS 133 (FIG. 1). The alternative discovery service identifier 224 may identify the alternative SM-DS 133 used in the cascaded provisioning process. The alternative discovery service response 227 indicates the response of the alternative SM-DS 133, which may be the address of an SM-DP+ 115 (FIG. 1) or an SM-DP 112 (FIG. 1).

The profile provisioning entity identifier 230 identifies the eSIM profile provisioning entity (e.g., the SM-DP+ 115 or the SM-DP 112) to whom the device 106 is referred by the alternative SM-DS 133. The profile provisioning entity address 233 is the address of the profile provisioning entity that is returned to the device 106 by the alternative SM-DS 133.

The signature 236 may comprise a hash code or other data generated based at least in part on a private key that enables the integrity of the record to be verified using a public key. For example, the signature 236 may be generated using the SHA-256 algorithm. The timestamp 237 may correspond to a date and/or time associated with the eSIM provisioning request. The record identifier 238 may be a sequence identifier that corresponds to the record and used in the indices 206 to point to individual records.

The event deletion request registry 239 stores information associated with event deletion requests, initiated by the profile provisioning entity such as the SM-DP 112 or the SM-DP+ once an eSIM profile is provisioned to a device 106 following the registration request. The information may include data fields similar to that of the event registration request registry 209, along with a signature 236, a timestamp 237, a record identifier 238, and so on.

The entitlement service transaction registry 240 may record transactions relating to enabling and/or disabling entitlements on devices 106, as well as supported entitlement/capability information for the devices 106. In some implementations, the entitlement transaction data may be indexed based at least in part on the unique device hardware identifier of the device 106. The entitlement transaction data in the entitlement service transaction registry 240 may also include a signature 236, a timestamp 237, a record identifier 238, and/or other data.

The device registry data 241 may record transactions relating to the device registry 141, including, for example, data received from device manufacturer systems 116, third-party device registries 117, the GSMA device registry 119, CSP systems 109, and so on. The device registry data 241 may include information relating to device capabilities and entitlements, device features and characteristics, and a device history of CSP activations and entitlements. In some implementations, the device registry data 241 may be indexed based at least in part on the unique device hardware identifier of the device 106. Records in the device registry data 241 may also include a signature 236, a timestamp 237, a record identifier 238, and/or other data.

Turning now to FIG. 2B, shown is one example of a networked environment 250 with an example deployment of the entitlement service aggregation layer 140 from FIG. 1 according to one or more embodiments. The entitlement service aggregation layer 140 integrates with a plurality of CSP systems 109a . . . 109N via a northbound interface 253 and with a plurality of device manufacturer systems (OEMs) 116a . . . 116N via a southbound interface 256. The northbound interface 253 may include a plurality of CSP interfaces 259a . . . 259N, which may be specific to respective APIs of each CSP system 109. In some cases, a particular CSP may be associated with two or more CSP systems 109, with each of the respective CSP systems 109 being integrated separately with the entitlement service aggregation layer 140 via a respective CSP interface 259. In other examples, the northbound interface 253 corresponds to a common or unified API published for use by each of the CSP systems 109. The southbound interface 256 may include a plurality of entitlement services 262a . . . 262N that integrate with respective APIs of the OEMs 116 to communicate with the OEMs 116 to obtain supported entitlement information, to enable entitlements for specific devices 106, to disable entitlements for specific devices 106, and so forth. An entitlement orchestration service 265 is between the northbound interface 253 and the southbound interface 256 in order to route and orchestrate requests from the CSP systems 109 with respect to the different OEMs 116. The entitlement orchestration service 265 is also configured to write transaction ledger 142 entries with respect to the entitlement transactions using the ledger registry service 136. In some implementations, entitlement services 262 may be operated by third parties different from the operator of the entitlement orchestration service 265 and the device manufacturer.

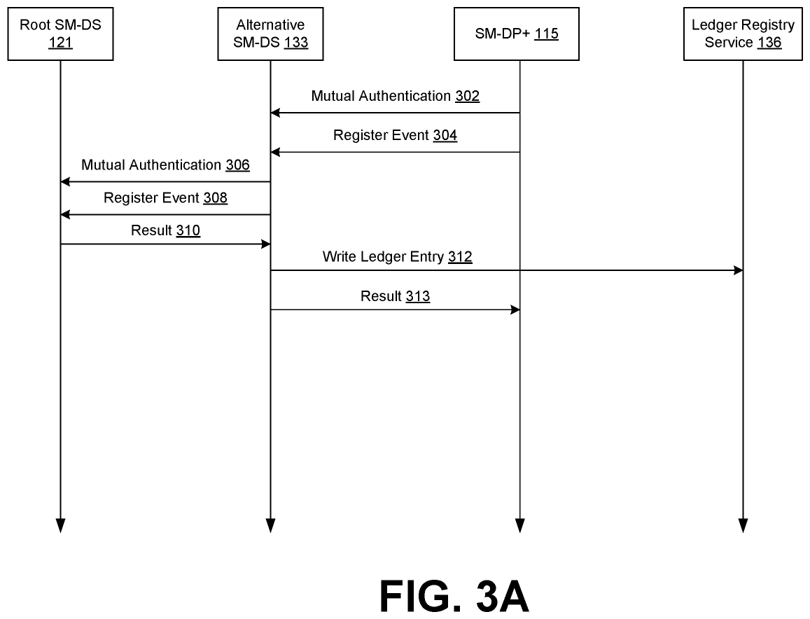

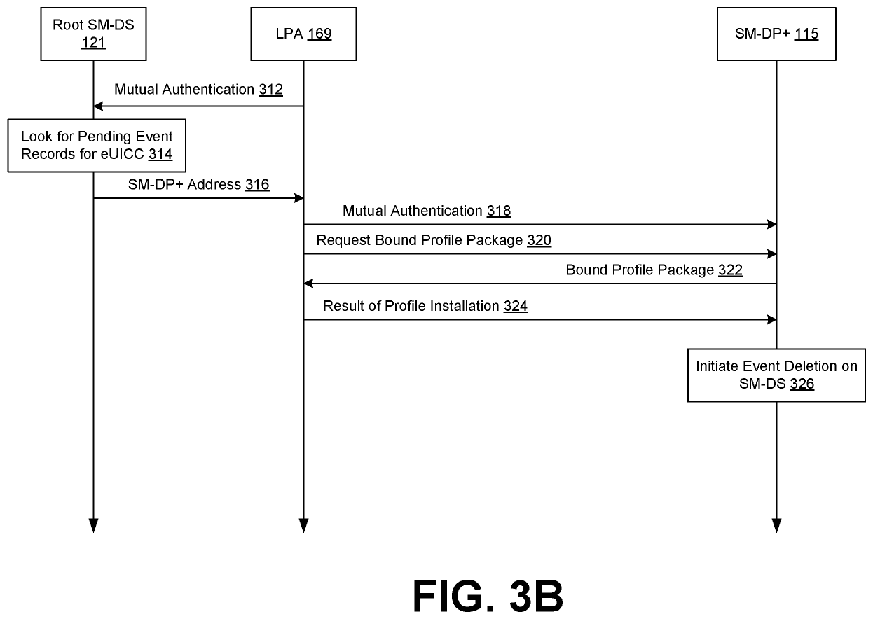

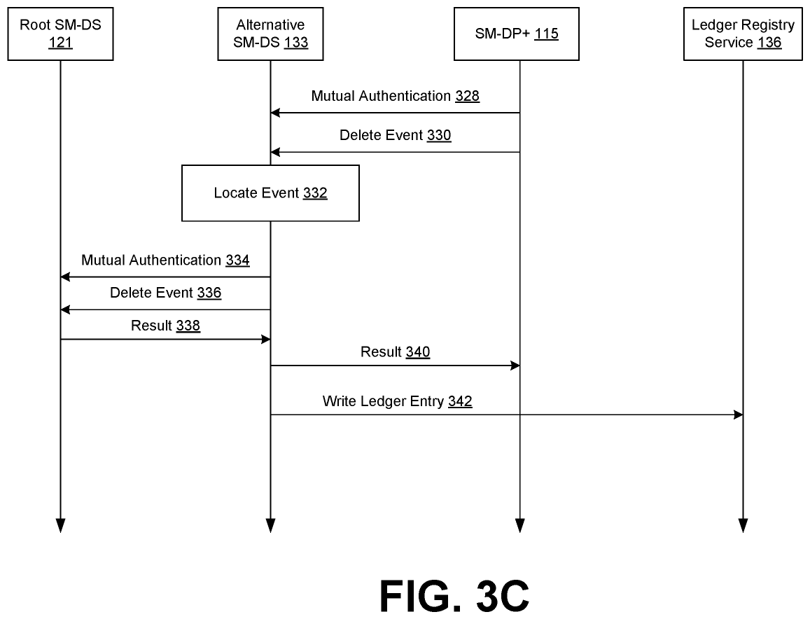

Referring next to FIG. 3A, shown is a sequence diagram that provides one example of the interactions between a root SM-DS 121 (or a GSMA SM-DS 118 (FIG. 1), an alternative SM-DS 133, an SM-DP+ 115 (or an SM-DP 112 (FIG. 1), and a ledger registry service 136 in order to register events according to various embodiments.

At 302, the SM-DP+ 115 and the alternative SM-DS 133 perform a mutual authentication procedure. At 304, the SM-DP+ 115 sends an event registration request to the alternative SM-DS 133. The request may specify data such as the eID, an address of the SM-DP+ 115, and a first event identifier. At 306, the alternative SM-DS 133 performs a mutual authentication procedure with a root SM-DS 121. At 308, the alternative SM-DS 133 sends the event registration request to the root SM-DS 121. The request may specify data such as the eID, an address of the SM-DP+ 115, and a second event identifier.

The root SM-DS 121 returns a result of the event registration request at 310 to the alternative SM-DS 133. The result may indicate success or an error status. At 312, the alternative SM-DS 133 writes a ledger entry to record the event registration information via the ledger registry service 136. The ledger entry may specify information such as the eID, an identifier of the alternative SM-DS 133, an identifier of the root SM-DS 121, the first event identifier used for the alternative SM-DS 133, the second event identifier used for the root SM-DS 121, the response of the alternative SM-DS 133, the response of the root SM-DS 121, an identifier of the SM-DP+ 115, an address of the SM-DP+ 115, a timestamp, and/or other information. The ledger registry service 136 may respond with an indication of success or an error. At 313, the alternative SM-DS 133 returns the result of the event registration request to the SM-DP+ 115.

Continuing to FIG. 3B, shown is a sequence diagram that provides one example of the interactions between a root SM-DS 121 (or a GSMA SM-DS 118 (FIG. 1), an LPA 169 or eLPA 175 (FIG. 1) of a device 106 (FIG. 1), and an SM-DP+ 115 (or an SM-DP 112 (FIG. 1) for eSIM discovery event retrieval according to various embodiments.

At 312, the LPA 169 performs a mutual authentication procedure with a root SM-DS 121. At 314, the root SM-DS 121 looks for any pending event records for the particular eUICC 163 (FIG. 1) identified by the eID. If an event is found, at 316, the root SM-DS 121 returns the address of an SM-DP+ 115 to the LPA 169.

At 318, the LPA 169 performs a mutual authentication procedure with the SM-DP+ 115 at the address returned by the root SM-DS 121. At 320, the LPA 169 requests a bound eSIM profile package from the SM-DP+ 115. At 322, the SM-DP+ 115 returns the bound eSIM profile package and a transaction identifier to the LPA 169. The LPA 169 proceeds to install the bound eSIM profile package on the eUICC 163, with an optional verification from the user. At 324, the LPA 169 returns a result of the profile installation to the SM-DP+ 115. At 326, the SM-DP+ 115 initiates event deletion for the corresponding event on the root SM-DS 121, which is described in more detail in the sequence diagram of FIG. 3C.

Moving on to FIG. 3C, shown is a sequence diagram that provides one example of the interactions between a root SM-DS 121 (or a GSMA SM-DS 118 (FIG. 1), an alternative SM-DS 133, an SM-DP+ 115 (or an SM-DP 112 (FIG. 1), and a ledger registry service 136 in order to delete events according to various embodiments.

At 328, the SM-DP+ 115 and the alternative SM-DS 133 perform a mutual authentication procedure. At 330, the SM-DP+ 115 sends an event deletion request to the alternative SM-DS 133. The request may specify information such as the eID and the first event identifier. At 332, the alternative SM-DS 133 attempts to locate the event. If no event is found, the alternative SM-DS 133 may return an error status to the SM-DP+ 115. At 334, if the event is found, the alternative SM-DS 133 performs a mutual authentication procedure with a root SM-DS 121. At 336, the alternative SM-DS 133 sends the event deletion request to the root SM-DS 121. The request may specify information such as the eID and the second event identifier.

The root SM-DS 121 returns a result of the event deletion request at 338 to the alternative SM-DS 133. The result may indicate success or an error status. If the result is success, the alternative SM-DS 133 also deletes the event. At 340, the alternative SM-DS 133 returns the result of the event deletion request to the SM-DP+ 115. At 342, the alternative SM-DS 133 writes a ledger entry to record the event deletion information via the ledger registry service 136.

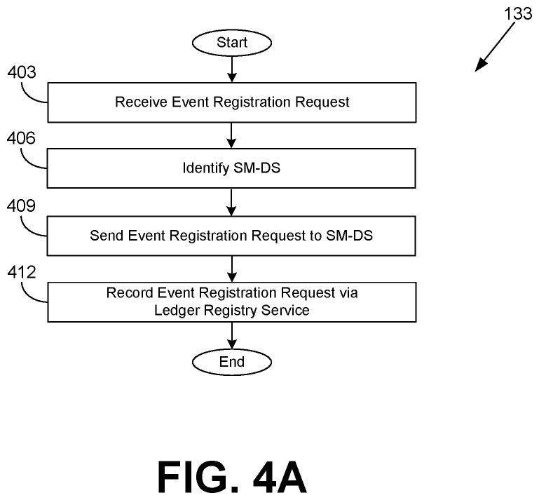

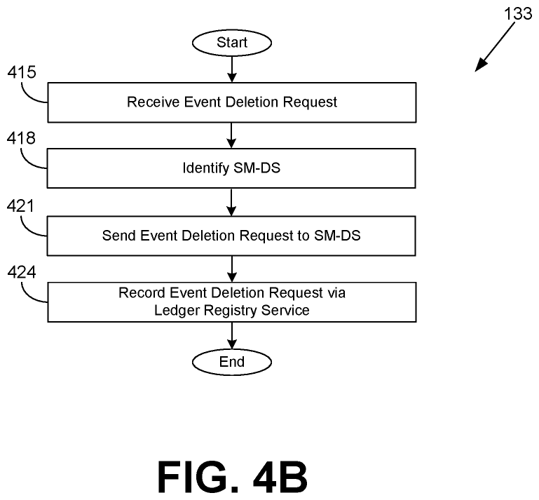

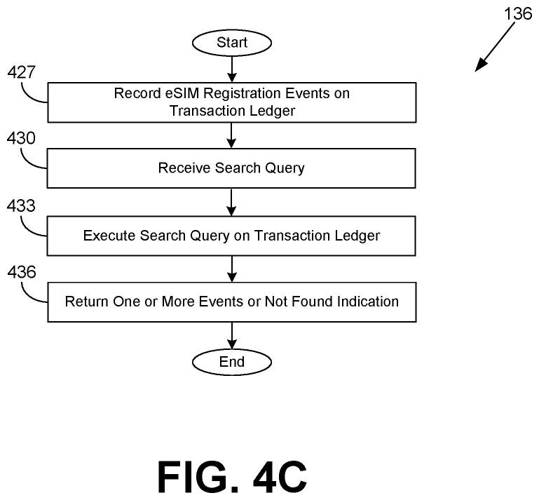

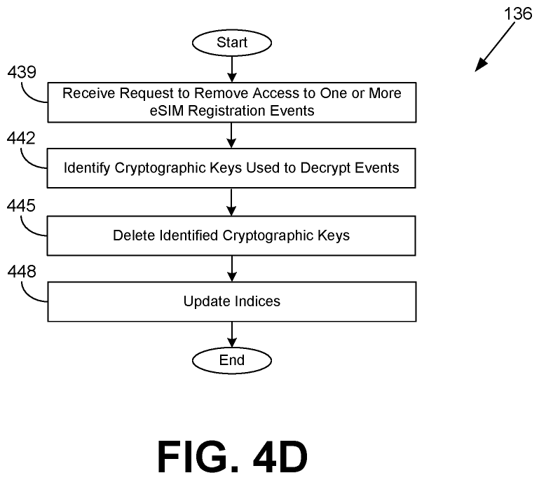

Referring next to FIG. 4A, shown is a flowchart that provides one example of the operation of a portion of the alternative SM-DS 133 according to various embodiments. It is understood that the flowchart of FIG. 4A provides merely an example of the many different types of functional arrangements that may be employed to implement the operation of the portion of the alternative SM-DS 133 as described herein. As an alternative, the flowchart of FIG. 4A may be viewed as depicting an example of elements of a method implemented in the computing environment 103 (FIG. 1) according to one or more embodiments.

Beginning with box 403, the alternative SM-DS 133 receives an event registration request from an SM-DP+ 115 (FIG. 1) of a CSP. For example, the request may specify a unique device hardware identifier 215 (FIG. 2A), such as an eID, and a profile provisioning entity address 233 (FIG. 2A), such as an address of the SM-DP+ 115 or an SM-DP 112. In box 406, the alternative SM-DS 133 identifies a particular root SM-DS 121 (FIG. 1) or the GSMA SM-DS 118 (FIG. 1). In box 409, the alternative SM-DS 133 sends an event registration request to the identified SM-DS. In box 412, the alternative SM-DS 133 records information regarding the event registration request via the ledger registry service 136. Thereafter, the operation of the portion of the alternative SM-DS 133 ends.

Turning now to FIG. 4B, shown is a flowchart that provides one example of the operation of another portion of the alternative SM-DS 133 according to various embodiments. It is understood that the flowchart of FIG. 4B provides merely an example of the many different types of functional arrangements that may be employed to implement the operation of the portion of the alternative SM-DS 133 as described herein. As an alternative, the flowchart of FIG. 4B may be viewed as depicting an example of elements of a method implemented in the computing environment 103 (FIG. 1) according to one or more embodiments.

Beginning with box 415, the alternative SM-DS 133 receives an event deletion request from an SM-DP+ 115 (FIG. 1). The event deletion request may specify a unique device hardware identifier 215 (FIG. 2A) such as an eID. In box 418, the alternative SM-DS 133 identifies a particular root SM-DS 121 (FIG. 1) or the GSMA SM-DS 118 (FIG. 1) associated with the event. In box 421, the alternative SM-DS 133 sends an event deletion request to the identified SM-DS. In box 424, the alternative SM-DS 133 records information regarding the event deletion request via the ledger registry service 136. Thereafter, the operation of the portion of the alternative SM-DS 133 ends.

Moving on to FIG. 4C, shown is a flowchart that provides one example of the operation of a portion of the ledger registry service 136 according to various embodiments. It is understood that the flowchart of FIG. 4C provides merely an example of the many different types of functional arrangements that may be employed to implement the operation of the portion of the ledger registry service 136 as described herein. As an alternative, the flowchart of FIG. 4C may be viewed as depicting an example of elements of a method implemented in the computing environment 103 (FIG. 1) according to one or more embodiments.

Beginning with box 427, the ledger registry service 136 records a plurality of eSIM registration or discovery events on the transaction ledger 142 (FIG. 1). In some implementations, the events may correspond to different CSPs. For example, the events may include a respective unique device hardware identifier 215 and/or other data as shown in FIG. 2A. The events may be encrypted using one or more cryptographic keys 203 (FIG. 2A) before being stored in the transaction ledger 142. In some cases, the ledger registry service 136 identifies a particular transaction ledger 142 from a plurality of transaction ledgers 142 based at least in part on a data locality rule that requires that certain data be stored in a particular geographic locality. In various embodiments, the transaction ledger 142 may correspond to a single node or may be distributed consistently across multiple nodes.

In box 430, the ledger registry service 136 receives a search query for historical transactions processed by the alternative SM-DS 133 (FIG. 1). The search query may specify a unique device hardware identifier 215, such an eID, or other data. For example, the search query may be received from the BSS 185 (FIG. 1) of a CSP system 109 (FIG. 1), from a system associated with a device manufacturer, or from a root SM-DS 121 (FIG. 1) or the GSMA SM-DS 118 (FIG. 1). In box 433, the ledger registry service 136 executes the search query on the transaction ledger 142 for the specified unique device hardware identifier 215 or other data. The ledger registry service 136 may perform the search using one or more indices 206.

In box 436, the ledger registry service 136 may return one or more events corresponding to historical transactions from the transaction ledger 142. In this regard, the ledger registry service 136 may decrypt the data using a corresponding cryptographic key 203 (FIG. 2A). In some cases, based on the requester, the ledger registry service 136 may anonymize data, such as the eID, that may be traceable to particular devices 106 or users in conjunction with other correlating data. In some cases, no historical transactions are associated with the unique device hardware identifier 215, in which case the ledger registry service 136 may return an indication that no historical transactions are found for the unique device hardware identifier 215. Thereafter, the operation of the portion of the ledger registry service 136 ends.

Continuing to FIG. 4D, shown is a flowchart that provides one example of the operation of another portion of the ledger registry service 136 according to various embodiments. It is understood that the flowchart of FIG. 4D provides merely an example of the many different types of functional arrangements that may be employed to implement the operation of the portion of the ledger registry service 136 as described herein. As an alternative, the flowchart of FIG. 4D may be viewed as depicting an example of elements of a method implemented in the computing environment 103 (FIG. 1) according to one or more embodiments.

Beginning with box 439, the ledger registry service 136 receives a request to remove access to one or more eSIM registration events, including event registration transactions on the event registration request registry 209 (FIG. 2A) and deletion transactions on the event deletion request registry 239 (FIG. 2A) of the transaction ledger 142 (FIG. 1). In box 442, the ledger registry service 136 identifies one or more cryptographic keys 203 (FIG. 2A) used to decrypt the target events. In box 445, the ledger registry service 136 proceeds to delete the identified cryptographic keys 203. While transactions recorded on the transaction ledger 142 are immutable, by discarding the cryptographic keys 203, the transactions can no longer be accessed or decrypted. In box 448, the ledger registry service 136 may update one or more indices 206 to remove references to the inaccessible transactions. Thereafter, the operation of the portion of the ledger registry service 136 ends.

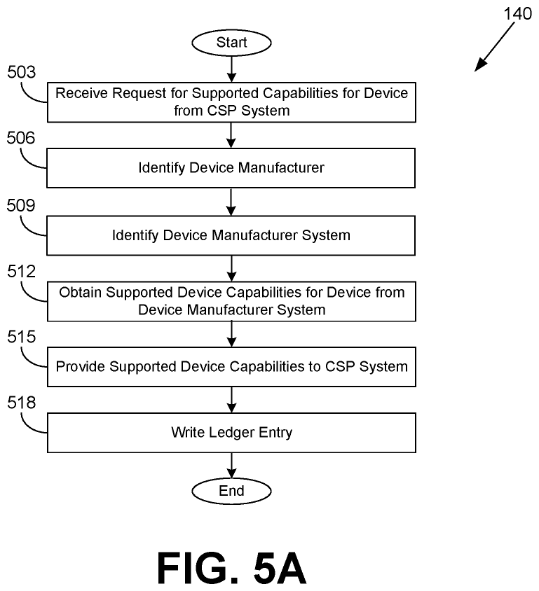

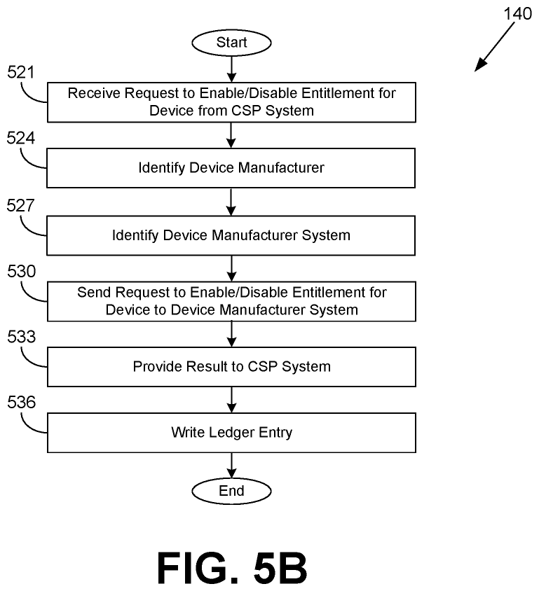

Turning now to FIG. 5A, shown is a flowchart that provides one example of the operation of a portion of the entitlement service aggregation layer 140 according to various embodiments. It is understood that the flowchart of FIG. 5A provides merely an example of the many different types of functional arrangements that may be employed to implement the operation of the portion of the entitlement service aggregation layer 140 as described herein. As an alternative, the flowchart of FIG. 5A may be viewed as depicting an example of elements of a method implemented in the computing environment 103 (FIG. 1) according to one or more embodiments.

Beginning with box 503, the entitlement service aggregation layer 140 receives a request for supported device capabilities for one or more particular devices 106 (FIG. 1) from a CSP system 109 (FIG. 1) (e.g., a BSS 185 (FIG. 1) on the CSP system 109). The capabilities may correspond to features that may be activated as entitlements via the CSP system 109. The request may identify the particular devices 106 by corresponding unique device hardware identifiers, such as the EID. The request may be received via a particular CSP interface 259 (FIG. 2B) with the CSP system 109 in the northbound interface 253 (FIG. 2B).

In box 506, the entitlement service aggregation layer 140 identifies the device manufacturer for the device 106 corresponding to the unique device hardware identifier. For example, the entitlement service aggregation layer 140 may query the device registry 141 based on the unique device hardware identifier in order to determine the manufacturer. Alternatively, the entitlement service aggregation layer 140 may have access of a mapping of ranges of unique device hardware identifiers that can identify a manufacturer for the given unique device hardware identifier. In box 509, the entitlement service aggregation layer 140 identifies a particular device manufacturer system (OEM) 116 (FIG. 1) corresponding to the manufacturer of the device 106.

In box 512, the entitlement service aggregation layer 140 obtains supported device capabilities for the device 106 from the particular OEM 116. As non-limiting examples, the supported device capabilities may comprise a mobile hotspot capability, a visual voicemail capability, a video calling capability, or other capabilities. The entitlement orchestration service 265 (FIG. 2B) in the entitlement service aggregation layer 140 may identify a particular entitlement service 262 (FIG. 2B) in the southbound interface 256 (FIG. 2B) that interfaces with the identified OEM 116, where the particular entitlement service 262 communicates with the OEM 116 to obtain the supported device capabilities.

In box 515, the entitlement service aggregation layer 140 provides the supported device capabilities for the device 106 to the CSP system 109 via the corresponding CSP interface 259 in the northbound interface 253. In box 518, the entitlement service aggregation layer 140 may write a ledger entry in the transaction ledger 142 (FIG. 1) using the ledger registry service 136 (FIG. 1) to record the supported device capabilities that are associated with the unique device hardware identifiers of the device 106. In some cases, the transaction ledger 142 may be identified out of a plurality of transaction ledgers 142 based on the transaction ledger being specific to the CSP, OEM, locality per data locality rules, and so forth. Thereafter, the operation of the portion of the entitlement service aggregation layer 140 ends.

Moving to FIG. 5B, shown is a flowchart that provides one example of the operation of another portion of the entitlement service aggregation layer 140 according to various embodiments. It is understood that the flowchart of FIG. 5B provides merely an example of the many different types of functional arrangements that may be employed to implement the operation of the portion of the entitlement service aggregation layer 140 as described herein. As an alternative, the flowchart of FIG. 5B may be viewed as depicting an example of elements of a method implemented in the computing environment 103 (FIG. 1) according to one or more embodiments.

Beginning with box 521, the entitlement service aggregation layer 140 receives a request to enable or disable one or more entitlements for one or more particular devices 106 (FIG. 1) from a CSP system 109 (FIG. 1) (e.g., a BSS 185 (FIG. 1) on the CSP system 109). The entitlements may correspond to capabilities supported by the devices 106. The request may be based at least in part on a subscription status of the device 106 with the corresponding CSP with respect to the entitlements. The request may identify the particular devices 106 by corresponding unique device hardware identifiers, such as the EID. The request may be received via a particular CSP interface 259 (FIG. 2B) with the CSP system 109 in the northbound interface 253 (FIG. 2B).

In box 524, the entitlement service aggregation layer 140 identifies the device manufacturer for the device 106 corresponding to the unique device hardware identifier. For example, the entitlement service aggregation layer 140 may query the device registry 141 based on the unique device hardware identifier in order to determine the manufacturer. Alternatively, the entitlement service aggregation layer 140 may have access of a mapping of ranges of unique device hardware identifiers that can identify a manufacturer for the given unique device hardware identifier. In box 527, the entitlement service aggregation layer 140 identifies a particular device manufacturer system (OEM) 116 (FIG. 1) corresponding to the manufacturer of the device 106.

In box 530, the entitlement service aggregation layer 140 sends the request to enable or disable the entitlement for the particular device 106 to the particular OEM 116. As non-limiting examples, the entitlements may comprise a mobile hotspot entitlement, a visual voicemail entitlement, a video calling entitlement, or other entitlements. The entitlement orchestration service 265 (FIG. 2B) in the entitlement service aggregation layer 140 may identify a particular entitlement service 262 (FIG. 2B) in the southbound interface 256 (FIG. 2B) that interfaces with the identified OEM 116, where the particular entitlement service 262 communicates with the OEM 116 to enable or disable the entitlement.

In box 533, the entitlement service aggregation layer 140 provides the result of enabling or disabling the entitlement for the device 106 to the CSP system 109 via the corresponding CSP interface 259 in the northbound interface 253. In box 536, the entitlement service aggregation layer 140 may write a ledger entry in the transaction ledger 142 (FIG. 1) using the ledger registry service 136 (FIG. 1) to record the enabling or disabling of the entitlement in association with the unique device hardware identifier of the device 106. In some cases, the transaction ledger 142 may be identified out of a plurality of transaction ledgers 142 based on the transaction ledger being specific to the CSP, OEM, locality per data locality rules, and so forth. Thereafter, the operation of the portion of the entitlement service aggregation layer 140 ends.

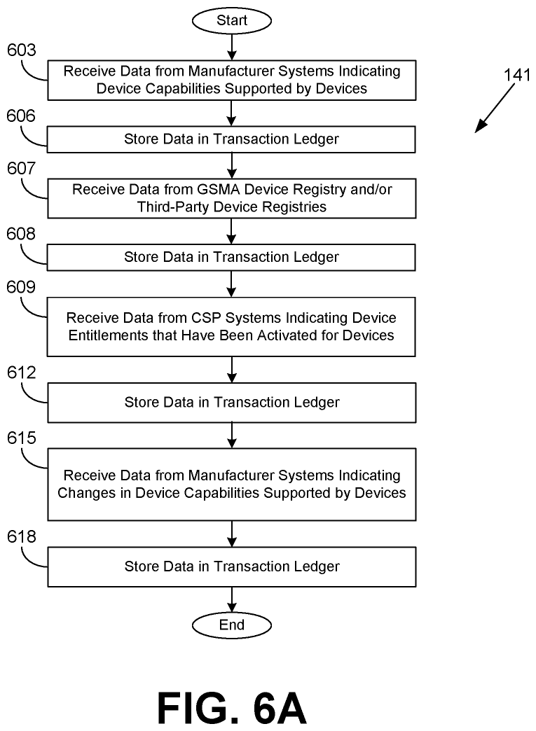

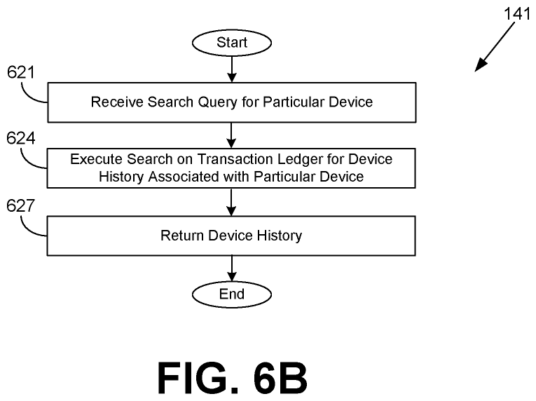

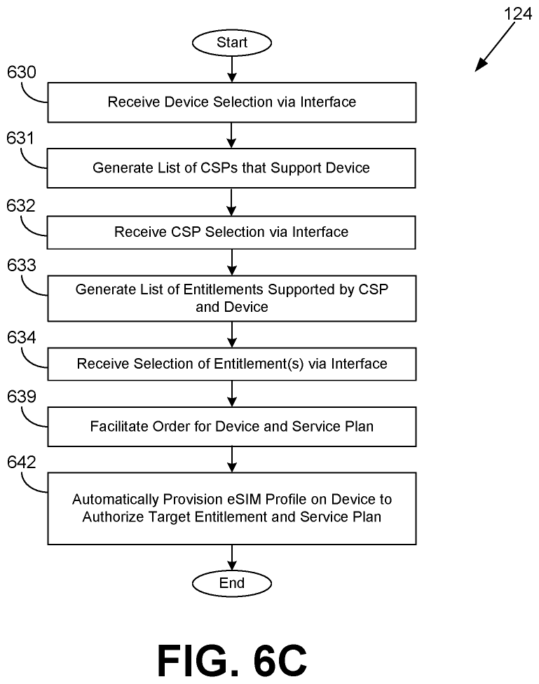

Referring next to FIG. 6A, shown is a flowchart that provides one example of the operation of a portion of the device registry 141 according to various embodiments. It is understood that the flowchart of FIG. 6A provides merely an example of the many different types of functional arrangements that may be employed to implement the operation of the portion of the device registry 141 as described herein. As an alternative, the flowchart of FIG. 6A may be viewed as depicting an example of elements of a method implemented in the computing environment 103 (FIG. 1) according to one or more embodiments.

Beginning with box 603, the device registry 141 receives data from a plurality of device manufacturer systems (OEMs) 116 (FIG. 1) indicating device capabilities that are supported by specific devices 106 (FIG. 1). The devices 106 may be identified in the data by corresponding unique device hardware identifiers (e.g., EIDs). The device registry 141 may receive the data periodically in a data feed or on demand. In box 606, the device registry 141 stores the data describing the device capabilities in the transaction ledger 142 (FIG. 1) via the ledger registry service 136 (FIG. 1). In box 607, the device registry 141 may also receive data feeds from the GSMA device registry 119 (FIG. 1), one or more third-party device registries 117, and/or other sources. In box 608, the device registry 141 may also store data received from the GSMA device registry 119 and/or the third-party device registries 117 in the transaction ledger 142 via the ledger registry service 136.

In box 609, the device registry 141 receives data from a plurality of CSP systems 109 (FIG. 1) that indicate second entitlements for specific devices 106 that have been enabled or activated for the devices 106. In box 612, the device registry 141 stores the data describing the device entitlements in the transaction ledger 142 via the ledger registry service 136. In some cases, a specific transaction ledger 142 corresponding to the particular CSP may be used to store data obtained from a CSP system 109 of the particular CSP, for scaling purposes and/or to segregate the data based on CSP.

In box 615, the device registry 141 may receive updated data from the device manufacturer systems 116 indicating one or more changes to the device capabilities that are supported by the devices 106 identified by their respective unique device hardware identifiers. For example, a software or firmware update may enable additional capabilities that were previously not supported in the device 106. In another scenario, a previously supported capability may be disabled by the manufacturer via a software or firmware update. In box 618, the device registry 141 stores the data describing the changes to the device capabilities in the transaction ledger 142, such as additional capabilities or removed capabilities, via the ledger registry service 136. Thereafter, the operation of the portion of the device registry 141 ends.

Continuing to FIG. 6B, shown is a flowchart that provides one example of the operation of another portion of the device registry 141 according to various embodiments. It is understood that the flowchart of FIG. 6B provides merely an example of the many different types of functional arrangements that may be employed to implement the operation of the portion of the device registry 141 as described herein. As an alternative, the flowchart of FIG. 6B may be viewed as depicting an example of elements of a method implemented in the computing environment 103 (FIG. 1) according to one or more embodiments.

In box 621, the device registry 141 receives a search query for the device history associated with a particular device 106 (FIG. 1). The search query may specify a unique device hardware identifier corresponding to the device 106. The search query may come from a CSP, an OEM, an EUM, and/or other entity authorized to query the device registry 141. In box 624, the device registry 141 executes a search on the transaction ledger 142 (FIG. 1) via the ledger registry service 136 (FIG. 1) using the unique device hardware identifier.

The scope of the search may be limited to portions of the transaction ledger 142 (or specific transaction ledgers 142 of a plurality of transaction ledgers 142) for which there is authorization to access. In box 627, the device registry 141 returns the resulting device history to the requestor. In one example, the device history may indicate that a device 106 has been previously activated on corresponding radio-based networks of a plurality of CSPs. In one example, the returned data may indicate a list of enabled entitlements for the device 106. Thereafter, the operation of the portion of the device registry 141 ends.

Referring next to FIG. 6C, shown is a flowchart that provides one example of the operation of a portion of the device ordering system 124 according to various embodiments. It is understood that the flowchart of FIG. 6C provides merely an example of the many different types of functional arrangements that may be employed to implement the operation of the portion of the device ordering system 124 as described herein. As an alternative, the flowchart of FIG. 6C may be viewed as depicting an example of elements of a method implemented in the computing environment 103 (FIG. 1) according to one or more embodiments.

Beginning with box 630, the device ordering system 124 receives a selection of a particular device 106 (FIG. 1) via an interface. For example, a selection of the device 106 may be received via a user interface or an API. The user may have entered a search query which is used to return a list of devices 106 that match the search query. In various scenarios, the user may search for the manufacturer name, device name, or a device capability. The user may additionally or alternatively be able to browse available devices by categories.

In box 631, the device ordering system 124 generates a list of CSPs that offer plans that support the selected device 106. This list may be generated based at least in part on a search of the device registry 141 and the corresponding transaction ledger(s) 142, which may aggregate data indicating activations of devices 106 on radio-based networks of the CSPs. In box 632, the device ordering system 124 receives a selection of a particular CSP and/or a specific CSP plan.

In box 633, the device ordering system 124 generates a list of entitlements corresponding to capabilities supported by the device 106 that are available to be activated (and in some cases, subscribed to) through the particular CSP or specific CSP plan. This list may be generated based at least in part on a search of the device registry 141 and the corresponding transaction ledger(s) 142, which aggregate data indicating activations of entitlements on radio-based networks of the CSPs and supported device capabilities.

In box 634, the device ordering system 124 receives a selection via the interface of one or more of the list of entitlements that are to be activated for the device 106 and corresponding CSP plan. For example, the user may check a box next to the particular entitlements that are desired. In some cases, the entitlements may be pre-selected and the user may be able to opt out of one or more entitlements.

In box 639, the device ordering system 124 facilitates an order of a particular device 106 and an order for a service plan from a CSP that supports the selected entitlement(s) on the particular device 106. In box 642, the device ordering system 124 automatically provisions an eSIM profile on the ordered device 106 to authorize the selected entitlement(s) and the service plan through the CSP. In one embodiment, the device 106 is preconfigured with bootstrap code that causes the device 106 to connect to a CSP or cloud provider upon initially being powered on. During this quarantine period, the eSIM profile is automatically provisioned on the device 106. The device ordering system 124 may proceed through an account creation process with the CSP system 109 in order to sign up for the service plan and reserve an eSIM profile via the SIM inventory 179 (FIG. 1). The device ordering system 124 may communicate with the EUM data generation system 127 (FIG. 1) identified by the particular CSP in order to request creation of the eSIM profile. When the device 106 is received by the end user and powered on, the device 106 receives the eSIM profile via the discovery process and is authorized to access the radio-based network of the CSP and to use the selected entitlement(s) in accordance with the service plan. Thereafter, the operation of the portion of the device ordering system 124 ends.

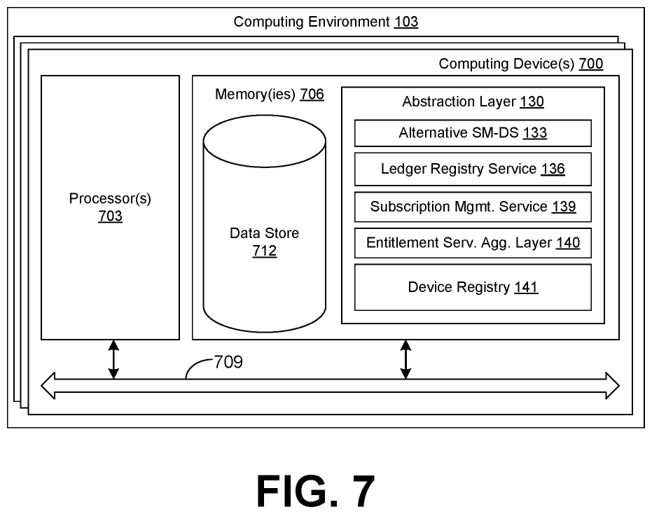

With reference to FIG. 7, shown is a schematic block diagram of the computing environment 103 according to an embodiment of the present disclosure. The computing environment 103 includes one or more computing devices 700. Each computing device 700 includes at least one processor circuit, for example, having a processor 703 and a memory 706, both of which are coupled to a local interface 709. To this end, each computing device 700 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 are the abstraction layer 130, including the alternative SM-DS 133, the ledger registry service 136, the subscription management service 139, the entitlement service aggregation layer 140, the device registry 141, and potentially other applications. Also stored in the memory 706 may be a data store 712 and other data. In addition, an operating system may be stored in the memory 706 and executable by the processor 703.

It is understood that there may be other applications that are stored in the memory 706 and are executable by the processor 703 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and/or multiple processor cores and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the abstraction layer 130 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams of FIGS. 3A-3C and the flowcharts of FIGS. 4A-6C show the functionality and operation of an implementation of portions of the networked environment 100 (FIG. 1). If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the sequence diagrams of FIGS. 3A-3C and the flowcharts of FIGS. 4A-6C show a specific order of execution, it is understood that the order of execution may differ from that which is depicted. For example, the order of execution of two or more blocks may be scrambled relative to the order shown. Also, two or more blocks shown in succession in FIGS. 3A-6C may be executed concurrently or with partial concurrence. Further, in some embodiments, one or more of the blocks shown in FIGS. 3A-6C may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the abstraction layer 130, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the abstraction layer 130, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 700, or in multiple computing devices 700 in the same computing environment 103.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Embodiments of the present disclosure may be described in one or more of the following clauses:

Clause 1. A system, comprising: a ledger registry service configured to maintain a transaction ledger recording electronic subscriber identity module (eSIM) discovery service transactions with respect to unique device hardware identifiers; and an abstraction layer configured to receive event registration requests and event deletion requests associated with the unique device hardware identifiers from a plurality of entities respectively operated by or on behalf of a plurality of connectivity service providers (CSPs), the abstraction layer being configured to send the event registration requests and the event deletion requests to a respective root subscription manager discovery service (SM-DS) from a plurality of root SM-DSes, the abstraction layer being configured to record the event registration requests and the event deletion requests via the ledger registry service.

Clause 2. The system of clause 1, wherein the abstraction layer functions as an alternative SM-DS.

Clause 3. The system of clauses 1 to 2, wherein the transaction ledger is immutable and cryptographically verifiable.

Clause 4. The system of clauses 1 to 3, wherein the ledger registry service and the abstraction layer are operable in an Internet-disconnected mode.

Clause 5. The system of clauses 1 to 4, wherein the ledger registry service and the abstraction layer are implemented on an edge server of a cloud provider network, and the ledger registry service facilitates searches of the transaction ledger for a particular unique device hardware identifier.

Clause 6. The system of clauses 1 to 5, wherein the abstraction layer receives the event deletion requests from a particular entity of the plurality of entities, the particular entity corresponding to a respective CSP of the plurality of CSPs, subsequent to a device obtaining profile data from a respective subscription manager data preparation (SM-DP) or SM-DP+ service operated by on behalf of the respective CSP, the device being provided with an address of the respective SM-DP or SM-DP+ by the respective root SM-DS.

Clause 7. A computer-implemented method, comprising: receiving an event registration request by an abstraction layer from an entity operated by or on behalf of a connectivity service provider (CSP), the event registration request specifying a unique device hardware identifier and at least one of: a subscription manager data preparation (SM-DP) address or a SM-DP+ address associated with the CSP; sending, by the abstraction layer, the event registration request to a subscription manager discovery service (SM-DS); and recording, by the abstraction layer, the event registration request via a ledger registry service.

Clause 8. The computer-implemented method of clause 7, further comprising: receiving an event deletion request by the abstraction layer from the entity, the event deletion request specifying the unique device hardware identifier; sending, by the abstraction layer, the event deletion request to the SM-DS; and recording, by the abstraction layer, the event deletion request via the ledger registry service.

Clause 9. The computer-implemented method of clauses 7 to 8, further comprising: receiving, by the abstraction layer, a historical transaction query for the unique device hardware identifier; searching a ledger of transactions via the ledger registry service for the unique device hardware identifier; and returning one or more historical transactions recorded by the ledger registry service for the unique device hardware identifier; or returning an indication that no historical transactions are recorded by the ledger registry service for the unique device hardware identifier.

Clause 10. The computer-implemented method of clause 7 to 9, wherein the ledger registry service implements an immutable and cryptographically verifiable ledger of transactions.

Clause 11. The computer-implemented method of clauses 7 to 10, wherein the abstraction layer comprises an alternative SM-DS.

Clause 12. The computer-implemented method of clauses 7 to 11, wherein the SM-DS is the GSM Association (GSMA) SM-DS.

Clause 13. A computer-implemented method, comprising: recording a plurality of electronic subscriber identity module (eSIM) registration events on a transaction ledger, individual ones of the plurality of eSIM registration events including a respective unique device hardware identifier, a respective discovery service identifier, and a respective discovery service response; receiving a search query specifying a particular unique device hardware identifier; executing the search query on the transaction ledger; and returning one or more of the plurality of eSIM registration events associated with the particular unique device hardware identifier; or returning an indication that no eSIM registration events are associated with the particular unique device hardware identifier.

Clause 14. The computer-implemented method of clause 13, wherein the individual ones of the plurality of eSIM registration events further include an alternative discovery service identifier, an alternative discovery service response, an identifier of an eSIM profile provisioning entity, and an address of the eSIM profile provisioning entity.

Clause 15. The computer-implemented method of clauses 13 to 14, further comprising encrypting the plurality of eSIM registration events before recordation on the transaction ledger.

Clause 16. The computer-implemented method of clauses 13 to 15, further comprising indexing the transaction ledger by the respective unique device hardware identifier.

Clause 17. The computer-implemented method of clauses 13 to 16, further comprising identifying the transaction ledger from a plurality of transaction ledgers based at least in part on a data locality rule.

Clause 18. The computer-implemented method of clauses 13 to 17, wherein the plurality of eSIM registration events recorded on the transaction register are immutable.

Clause 19. The computer-implemented method of clause 18, further comprising: receiving a request to remove access to one or more of the plurality of eSIM registration events; and identifying one or more cryptographic keys used to decrypt the one or more of the plurality of eSIM registration events; and deleting the one or more cryptographic keys.

Clause 20. The computer-implemented method of clauses 13 to 19, wherein at least two of the plurality of eSIM registration events correspond to different connectivity service providers.

Clause 21. A system, comprising: an entitlement service aggregation layer implemented in a computing device and configured to at least: receive entitlement queries from a plurality of first systems respectively operated by or on behalf of a plurality of communication service providers (CSPs), the entitlement queries specifying a respective unique device hardware identifier; send the entitlement queries to respective ones of a plurality of second systems respectively operated by or on behalf of a plurality of device manufacturers; receive responses to the entitlement queries from the respective ones of the plurality of second systems; and return the responses to corresponding ones of the plurality of first systems; and a ledger registry service implemented in the computing device and configured to at least record the entitlement queries and the responses on a transaction ledger.

Clause 22. The system of clause 21, wherein entries on the transaction ledger are immutable and cryptographically verifiable.

Clause 23. The system of clauses 21 to 22, wherein the entitlement queries are received by way of a common application programming interface (API) implemented in the entitlement service aggregation layer.

Clause 24. The system of clauses 21 to 23, wherein the entitlement service aggregation layer is further configured to: receive requests to enable or disable an entitlement from the plurality of first systems based at least in part on a subscription status associated with a corresponding device; and send the requests to enable or disable the entitlement to the respective ones of the plurality of second systems.

Clause 25. The system of clause 24, wherein the entitlement comprises at least one of: a mobile hotspot entitlement, a visual voicemail entitlement, or a video calling entitlement.

Clause 26. The system of clauses 21 to 25, wherein the entitlement service aggregation layer includes a plurality of northbound integrations with the plurality of first systems and a plurality of southbound integrations with the plurality of second systems.

Clause 27. The system of clause 26, wherein the plurality of southbound integrations comprise a plurality of entitlement services that are specific to the respective ones of the plurality of second systems.

Clause 28. A computer-implemented method, comprising: receiving a request for supported device capabilities for a device from a first system operated by or on behalf of a communication service provider (CSP), the device being identified by a unique device hardware identifier; identifying a manufacturer of the device based at least in part on the unique device hardware identifier; identifying a second system operated by or on behalf of the manufacturer of the device; obtaining the supported device capabilities for the device from the second system; and providing the supported device capabilities for the device to the first system.

Clause 29. The computer-implemented method of clause 28, further comprising recording the supported device capabilities in association with a unique device hardware identifier.

Clause 30. The computer-implemented method of clause 29, wherein the supported device capabilities and the unique device hardware identifier are recorded in a transaction ledger that is immutable and cryptographically verifiable.

Clause 31. The computer-implemented method of clause 30, wherein recording the supported device capabilities in association with the unique device hardware identifier further comprises identifying the transaction ledger from a plurality of CSP-specific transaction ledgers based at least in part on the CSP.

Clause 32. The computer-implemented method of clauses 28 to 31, further comprising: receiving a request to enable a particular entitlement corresponding to one of the supported device capabilities for the device from the first system; sending the request to enable the particular entitlement to the second system; recording the request to enable the particular entitlement on a transaction ledger; and providing a result of the request to enable the particular entitlement to the first system.

Clause 33. The computer-implemented method of clauses 28 to 32, further comprising: receiving a request to disable a particular entitlement corresponding to one of the supported device capabilities for the device from the first system; sending the request to disable the particular entitlement to the second system; recording the request to disable the particular entitlement on a transaction ledger; and providing a result of the request to disable the particular entitlement to the first system.

Clause 34. The computer-implemented method of clauses 28 to 33, further comprising: receiving a request for a list of enabled entitlements for the device; searching a transaction ledger for the unique device hardware identifier to determine the list of enabled entitlements; and returning the list of enabled entitlements.

Clause 35. A computer-implemented method, comprising: receiving a request to enable or disable an entitlement for a device from a first system operated by or on behalf of a communication service provider (CSP), the device being identified by a unique device hardware identifier; identifying a manufacturer of the device based at least in part on the unique device hardware identifier; identifying a second system operated by or on behalf of the manufacturer of the device; sending the request to enable or disable the entitlement to the second system; and providing a result associated with the request to the first system.

Clause 36. The computer-implemented method of clause 35, wherein sending the request to enable or disable the entitlement to the second system is performed by an entitlement service specific to the manufacturer.

Clause 37. The computer-implemented method of clauses 35 to 36, further comprising recording the request and the result in association with the unique device hardware identifier on a transaction ledger.

Clause 38. The computer-implemented method of clauses 35 to 37, further comprising determining whether a capability corresponding to the entitlement is supported for the device by the manufacturer based at least in part on a search of a device registry.

Clause 39. The computer-implemented method of clauses 35 to 38, further comprising determining whether the entitlement is enabled for the device by the CSP based at least in part on a search of a device registry.

Clause 40. The computer-implemented method of clauses 35 to 39, further comprising determining whether the entitlement has been previously enabled for the device by another CSP based at least in part on a search of a device registry.

Clause 41. A system, comprising: a device registry storing: data from a plurality of manufacturer systems indicating device capabilities supported by a plurality of particular devices identified by a respective unique device hardware identifier; and data from a plurality of communication service providers (CSP) indicating device entitlements for a set of the plurality of particular devices that have been activated on a respective radio-based network; and a device ordering system configured to at least: receive a selection of a device via an interface; receive a selection of a CSP that supports the device via the interface; and generate, based at least in part on the device capabilities and the device entitlements in the device registry, a list of entitlements supported by the device and the CSP.

Clause 42. The system of clause 41, wherein the device registry is configured to receive periodic data feeds from the plurality of manufacturer systems and the plurality of CSPs.

Clause 43. The system of clauses 41 to 42, wherein the device registry further stores data regarding the device from an external device registry operated by the Global System for Mobile Communications Association (GSMA).

Clause 44. The system of clauses 41 to 43, wherein the device registry is configured to receive updated data from the plurality of manufacturer systems indicating that additional device capabilities are supported by the device due to a software or firmware update.

Clause 45. The system of clauses 41 to 44, wherein the device registry is configured to receive updated data from the plurality of manufacturer systems indicating that a device capability previously supported for the device is no longer supported by the device due to a software or firmware update.

Clause 46. The system of clauses 41 to 45, wherein the device ordering system is further configured to at least: receive a selection of one or more of the list of entitlements; facilitate an order for the device having a service plan from the CSP; and configure the device with bootstrap code to enter a quarantine period upon being initially powered on, wherein an electronic subscriber identity module (eSIM) profile is automatically provisioned on the device during the quarantine period to authorize the one or more of the list of entitlements and the service plan with the CSP.

Clause 47. The system of clause 46, wherein automatically provisioning the eSIM profile further comprises: requesting an account creation with the CSP; receiving an identification of an Embedded Universal Integrated Circuit Card (eUICC) manufacturer system from the CSP; and requesting that the eUICC manufacturer system create the eSIM profile.

Clause 48. The system of clauses 41 to 47, wherein the device registry comprises a transaction ledger that is immutable and cryptographically verifiable.

Clause 49. A computer-implemented method, comprising: receiving data from a plurality of manufacturer systems indicating device capabilities supported by a plurality of particular devices identified by a respective unique device hardware identifier; storing the data indicating the device capabilities in a transaction ledger; receiving data from a plurality of communication service providers (CSP) indicating device entitlements for a set of the plurality of particular devices that have been activated on a respective radio-based network; and storing the data indicating the device entitlements in the transaction ledger.

Clause 50. The computer-implemented method of clause 49, further comprising: receiving updated data from the plurality of manufacturer systems indicating additional device capabilities supported by the plurality of particular devices identified by the respective unique device hardware identifier, the additional device capabilities being enabled by respective software or firmware updates for the plurality of particular devices; and storing the updated data indicating the additional device capabilities in the transaction ledger.

Clause 51. The computer-implemented method of clauses 49 to 50, wherein the device entitlements correspond to a subset of the device capabilities that have been subscribed to for the set of the plurality of particular devices with a corresponding CSP and are supported by the corresponding CSP.

Clause 52. The computer-implemented method of clauses 49 to 51, further comprising: receiving a search query regarding a device history for a particular device identified by a particular unique device hardware identifier; executing a search on the transaction ledger for the device history associated with the particular unique device hardware identifier; and returning the device history for the particular unique device hardware identifier, the device history including transactions respecting at least two of the plurality of CSPs.

Clause 53. The computer-implemented method of clauses 49 to 52, wherein the transaction ledger is an immutable and cryptographically verifiable ledger.

Clause 54. The computer-implemented method of clauses 49 to 53, wherein the transaction ledger comprises a plurality of CSP-specific transaction ledgers, and data from individual ones of the plurality of CSPs are recorded in a corresponding one of the plurality of CSP-specific transaction ledgers.

Clause 55. The computer-implemented method of clauses 49 to 54, further comprising: receiving data regarding the set of the plurality of particular devices from a device registry operated by the Global System for Mobile Communications Association (GSMA); and storing the data regarding the set of the plurality of particular devices in the transaction ledger.

Clause 56. A computer-implemented method, comprising: storing, in a device registry, data from a plurality of manufacturer systems indicating device capabilities supported by a plurality of particular devices identified by a respective unique device hardware identifier; receiving a selection of a device via an interface; and determining, based at least in part on the device capabilities in the device registry, a list of entitlements supported by a communication service provider (CSP) for the device.

Clause 57. The computer-implemented method of clause 56, wherein the list of entitlements comprises at least one of: a mobile hotspot entitlement, a visual voicemail entitlement, or a video calling entitlement.

Clause 58. The computer-implemented method of clauses 56 to 57, further comprising: facilitating an order for the device and a service plan that supports a selected subset of the list of entitlements; and automatically provisioning an electronic subscriber identity module (eSIM) profile on the device that authorizes the selected subset of the list of entitlements.

Clause 59. The computer-implemented method of clauses 56 to 58, further comprising: storing, in the device registry, data from a plurality of communication service providers (CSP) indicating device entitlements for a set of the plurality of particular devices that have been activated on a respective radio-based network; and wherein the list of entitlements is based at least in part on the device entitlements activated for the CSP.

Clause 60. The computer-implemented method of clauses 56 to 59, further comprising: requesting an account creation with the CSP; receiving an identification of an Embedded Universal Integrated Circuit Card (eUICC) manufacturer system from the CSP; and requesting that the eUICC manufacturer system create the eSIM profile.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a ledger registry service configured to maintain a transaction ledger recording electronic subscriber identity module (eSIM) discovery service transactions with respect to unique device hardware identifiers; and
an abstraction layer configured to receive event registration requests and event deletion requests associated with the unique device hardware identifiers from a plurality of entities respectively operated by or on behalf of a plurality of connectivity service providers (CSPs), the abstraction layer being configured to send the event registration requests and the event deletion requests to a respective root subscription manager discovery service (SM-DS) from a plurality of root SM-DSes, the abstraction layer being configured to record the event registration requests and the event deletion requests via the ledger registry service.

2. The system of claim 1, wherein the abstraction layer functions as an alternative SM-DS.

3. The system of claim 1, wherein the transaction ledger is immutable and cryptographically verifiable.

4. The system of claim 1, wherein the ledger registry service and the abstraction layer are operable in an Internet-disconnected mode.

5. The system of claim 1, wherein the ledger registry service and the abstraction layer are implemented on an edge server of a cloud provider network, and the ledger registry service facilitates searches of the transaction ledger for a particular unique device hardware identifier.

6. The system of claim 1, wherein the abstraction layer receives the event deletion requests from a particular entity of the plurality of entities, the particular entity corresponding to a respective CSP of the plurality of CSPs, subsequent to a device obtaining profile data from a respective subscription manager data preparation (SM-DP) or SM-DP+ service operated by on behalf of the respective CSP, the device being provided with an address of the respective SM-DP or SM-DP+ by the respective root SM-DS.

7. A computer-implemented method, comprising:
receiving an event registration request by an abstraction layer from an entity operated by or on behalf of a connectivity service provider (CSP), the event registration request specifying a unique device hardware identifier and at least one of: a subscription manager data preparation (SM-DP) address or a SM-DP+ address associated with the CSP;
sending, by the abstraction layer, the event registration request to a subscription manager discovery service (SM-DS); and
recording, by the abstraction layer, the event registration request via a ledger registry service.

8. The computer-implemented method of claim 7, further comprising:
receiving an event deletion request by the abstraction layer from the entity, the event deletion request specifying the unique device hardware identifier;
sending, by the abstraction layer, the event deletion request to the SM-DS; and
recording, by the abstraction layer, the event deletion request via the ledger registry service.

9. The computer-implemented method of claim 7, further comprising:
receiving, by the abstraction layer, a historical transaction query for the unique device hardware identifier;
searching a ledger of transactions via the ledger registry service for the unique device hardware identifier; and
returning one or more historical transactions recorded by the ledger registry service for the unique device hardware identifier; or
returning an indication that no historical transactions are recorded by the ledger registry service for the unique device hardware identifier.

10. The computer-implemented method of claim 7, wherein the ledger registry service implements an immutable and cryptographically verifiable ledger of transactions.

11. The computer-implemented method of claim 7, wherein the abstraction layer comprises an alternative SM-DS.

12. The computer-implemented method of claim 7, wherein the SM-DS is the GSM Association (GSMA) SM-DS.

13. A computer-implemented method, comprising:
recording a plurality of electronic subscriber identity module (eSIM) registration events on a transaction ledger, individual ones of the plurality of eSIM registration events including a respective unique device hardware identifier, a respective discovery service identifier, and a respective discovery service response;
receiving a search query specifying a particular unique device hardware identifier;
executing the search query on the transaction ledger; and
returning one or more of the plurality of eSIM registration events associated with the particular unique device hardware identifier; or
returning an indication that no eSIM registration events are associated with the particular unique device hardware identifier.

14. The computer-implemented method of claim 13, wherein the individual ones of the plurality of eSIM registration events further include an alternative discovery service identifier, an alternative discovery service response, an identifier of an eSIM profile provisioning entity, and an address of the eSIM profile provisioning entity.

15. The computer-implemented method of claim 13, further comprising encrypting the plurality of eSIM registration events before recordation on the transaction ledger.

16. The computer-implemented method of claim 13, further comprising indexing the transaction ledger by the respective unique device hardware identifier.

17. The computer-implemented method of claim 13, further comprising identifying the transaction ledger from a plurality of transaction ledgers based at least in part on a data locality rule.

18. The computer-implemented method of claim 13, wherein the plurality of eSIM registration events recorded on the transaction register are immutable.

19. The computer-implemented method of claim 18, further comprising:
receiving a request to remove access to one or more of the plurality of eSIM registration events; and
identifying one or more cryptographic keys used to decrypt the one or more of the plurality of eSIM registration events; and
deleting the one or more cryptographic keys.

20. The computer-implemented method of claim 13, wherein at least two of the plurality of eSIM registration events correspond to different connectivity service providers.
